(19) United States
(12) Patent Application Publication
(10) Pub. No.: US 2009/0160399 A1
(43) Pub. Date: Jun. 25, 2009

(54) Case Battery

(76) Inventor: Steven Woud, Los Angeles, CA (US)

Correspondence Address: PARK LAW FIRM, 3255 WILSHIRE BLVD, SUITE 1110, LOS ANGELES, CA, 90010, US

(21) Appl. No.: 11/963,692

(22) Filed: Dec. 21, 2007

(51) Int. Cl. H02J 7/00

(52) U.S. Cl. 320/115

(57) ABSTRACT

A case battery is provided. The case battery comprises first and second holding portions, a charging portion, and storage devices. The first holding portion is configured to hold a first part of the personal electronic device. The second holding portion is configured to hold a second part. The charging portion is disposed in the first base plate of the first holding portion. The storage devices are disposed in one of the first base plates of the first and the second base plates of the second holding portions. The first and second holding portions are configured to enclose and hold at least part of the personal electronic device and provide additional electrical power and memory capacity to the personal electronic device.

### BACKGROUND OF THE INVENTION

The present invention relates to a case battery. More particularly, this invention relates to a case battery with storage, which extends the usage time of a personal electronic device with more electrical power provided and provide more memory capacity.

“Portable” is one of the keywords which define the era of the information technology. Computing power had been an obstacle to make the technology portable for a long time. Considering the first computer, it would be easy to understand the situation. With the advent of the transistors and integrated circuit, however, computing power can be crammed in a really small space such that locating the heart of a computer inside the computer or even on a mother board is not easy, actually challenging to a layman. Once the computing power became no problem for a portability, it has taken a very short time to recognize the hard fact that the power source of battery and the memory capacity are the serious problem, which seems to be much harder to solve than the CPU problem somehow.

Since 1990's, portable electronic devices such as a cellular phone, PDA, etc. have become indispensable commodities to every one. The portable electronic devices need to be charged very frequently such that the usage is critically limited.

Accordingly, a need for a case battery for a personal electronic device or a portable personal electronic device has been present for a long time. This invention is directed to solve these problems and satisfy the long-felt need.

### SUMMARY OF THE INVENTION

The present invention contrives to solve the disadvantages of the prior art.

An objective of the invention is to provide a case battery for a personal electronic device.

Another object of the invention is to provide a case battery for a personal electronic device, which can extend the usage time of the personal electronic device.

Still another object of the invention is to provide a case battery for a personal electronic device, which provides a dock for charging the personal electronic device and a battery in the case battery. Also, the dock may provide a connection to other electronic device such as computer or cellphone.

An aspect of the invention provides a case battery for a personal electronic device. The case battery include a bottom holding portion, a rear plate portion, a top holding portion, a charging portion, and a circuit chamber.

The bottom holding portion is configured to hold a lower part of the personal electronic device and provide a plurality of external interfacing devices with access to the personal electronic device.

The rear plate portion is configured to be attached detachably to the bottom holding portion mechanically and electrically and protect a rear portion of the personal electronic device.

The top holding portion is configured to hold a top part of the personal electronic device and provide access holes to at least part of input and output devices of the personal electronic device.

The charging portion is disposed in the rear plate portion, and configured to be electrically connected to the personal electronic device while the personal electronic device is installed in the case battery.

The circuit compartment is disposed in the rear plate portion, and configured to connect the charging portion to the personal electronic device.

The bottom holding portion may include a first connector, a plurality of holes, and a plurality of resonance chambers.

The first connector may be configured to electrically connect the case battery to the personal electronic device, and include a power connector and a electrical signal connector.

The plurality of holes may be configured to pass sound from a speaker of the personal electrical device, and disposed on a front side or a corner between the front and rear sides of the bottom holding portion.

The plurality of resonance chambers may be provided between the speaker and the plurality of holes, and configured to resonate the sound from the speaker.

The bottom holding portion may engage side edges of the personal electronic device and expose a substantial part of a display screen of the personal electronic device.

The bottom holding portion may further comprise a first mechanical fastener, and the rear plate portion may comprise a second mechanical fastener corresponding to the first mechanical fastener. The bottom holding portion and the rear plate portion may be attached and locked to each other by the first and second mechanical fastener.

The charging portion may further includes a secondary battery and configured to be charged using an external electrical power source, or a primary battery and a receptacle configured to accept the primary battery.

The circuit compartment may be configured to control behaviors of the charging portion.

In another embodiments of the invention, the case battery may further include a connector adaptor, a multi-purpose connector, and a dock.

The connector adaptor may be configured to be attached detachably to the bottom holding portion, and include a plurality of locks configured to lock the connector adapter to the bottom holding portion, a release button configured to release the connector adaptor from the bottom holding portion, and a multi-purpose receptacle.

The multi-purpose connector may be configured to be connected to the multi-purpose receptacle of the connector adaptor, and include a USB connector and a power connector.

The dock may be configured to accept the bottom holding portion attached to the personal electronic device and provide access to electrical power from externally to charge the charging portion and access to information to communicate between the personal electronic device and an external device.

The dock may include a holding cup, a spring connector, a plurality of locks, a release button, a second connector, a connector receptacle, and a charging indicator.

The holding cup may be configured to accept and engage at least part of the bottom holding portion.

The spring connector may be configured to connect the bottom holding portion to the dock, and disposed at a bottom of the holding cup.

The plurality of locks may be configured to lock the bottom holding portion in place.

The release button may be configured to release the bottom holding portion from the plurality of locks.

The second connector may be configured to electrically connect the first connector to an external device;

The connector receptacle may be configured to accept the external device.

The charging indicator may be configured to monitor a charging status of the charging portion and the battery of the personal electronic device.

The charging portion may be replaceable, and the charging portion may have a predetermined thickness according to a capacity of the charging portion. Then the holding cup may be adjustable or replaceable according to the various thickness and size of the case battery.

The bottom holding portion may further include a case speaker connected to the personal electronic device and an deactivation switch. The dock may further include a bump configured to press the deactivation switch when the bottom holding portion is installed on the dock so as to deactivate the case speaker.

The top holding portion may include a third mechanical fastener, and the rear plate portion may include a fourth mechanical fastener corresponding to the third mechanical fastener. The top holding portion and the rear plate portion may be attached and locked to each other by the third and fourth mechanical fasteners.

The case battery may further include a connector adaptor configured to be attached detachably to the bottom holding portion, and the connector adaptor may comprise a plurality of locks configured to lock the connector adapter to the bottom holding portion, a release button configured to release the connector adaptor from the bottom holding portion, and a multi-purpose receptacle. The bottom holding portion may further comprise a guide recess and a locking recess at a lower part such that the connector adapter is guided to be connected to the bottom holding portion.

The connector adaptor may include a charging status of the charging portion and the battery of the electronic device.

The personal electronic device may comprise a portable game machine, a cellular phone, a PDA, a palmtop, and a GPS.

The advantages of the present invention are: (1) the case battery can extend the usage time of the personal electronic device; and (2) the case battery can be charged and connected to other devices conveniently on a dock.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a front plan view showing a case battery installed on a personal electronic device according to an embodiment of the present invention;

FIG. 2 is a front plan view of an exploded case battery according to an embodiment of the present invention;

FIG. 3 is another front plan view of an exploded case battery according to another embodiment of the present invention;

FIG. 4 is still another front plan view of an exploded case battery according to still another embodiment of the present invention;

FIG. 5 is a rear plan view of an exploded case battery according to an embodiment of the present invention;

FIG. 6 is a top plan view of a case battery according to an embodiment of the present invention;

FIG. 7 is a bottom plan view of a case battery according to an embodiment of the present invention;

FIG. 8 is a side plan view of an exploded case battery according to an embodiment of the present invention;

FIG. 9 is another side plan view of an exploded case battery according to an embodiment of the present invention;

FIG. 10 is a side cross-sectional view of a case battery with a regular rear plate portion without a charging portion and a circuit compartment installed according to an embodiment of the present invention;

FIG. 11 is a partial side cross-sectional view of a case battery with a rear plate portion with a charging portion installed according to an embodiment of the present invention;

FIG. 12 a side cross-sectional view of a case battery with a rear plate portion with a charging portion installed according to an embodiment of the present invention;

FIG. 13 is a side cross-sectional view of a bottom holding portion with a connector adaptor and a multi-purpose connector installed according to an embodiment of the present invention;

FIG. 14 is a top plan view of a dock according to an embodiment of the invention;

FIG. 15 is a front plan view of the dock in FIG. 14;

FIG. 16 is a rear plan view of the dock in FIG. 14;

FIG. 17 is a side cross-sectional view of a bottom holding portion installed on a dock according to an embodiment of the invention; and

FIG. 18 is a side plan view of a dock according to another embodiment of the invention.

### DETAILED DESCRIPTION EMBODIMENTS OF THE INVENTION

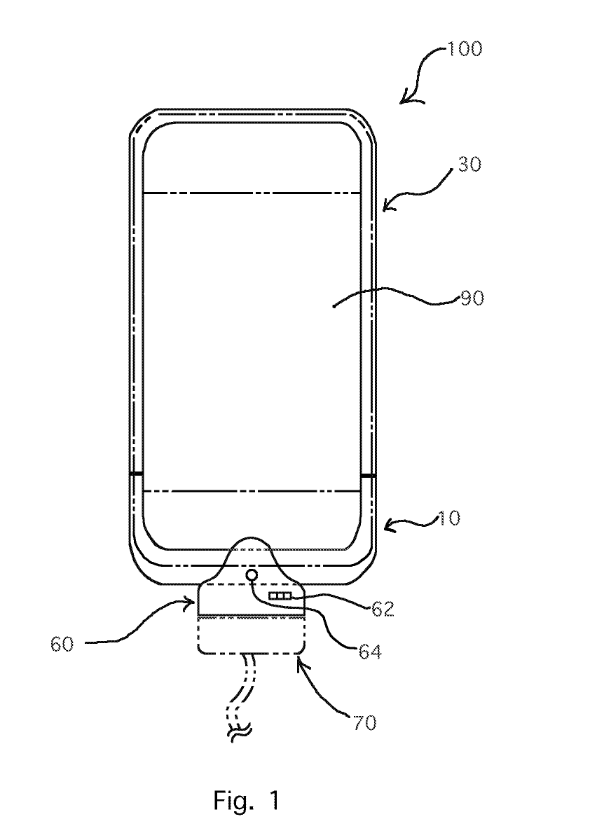

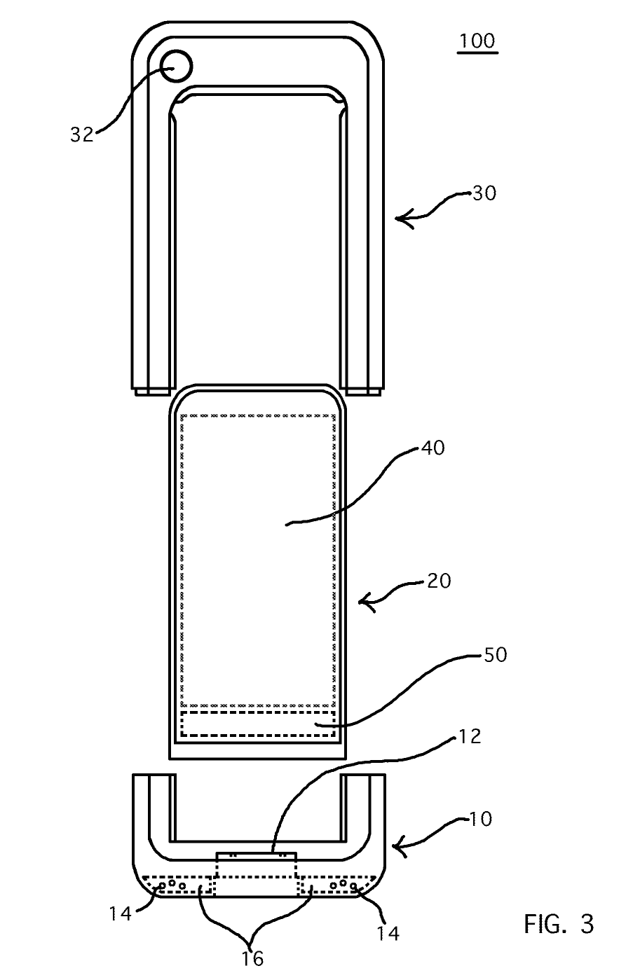

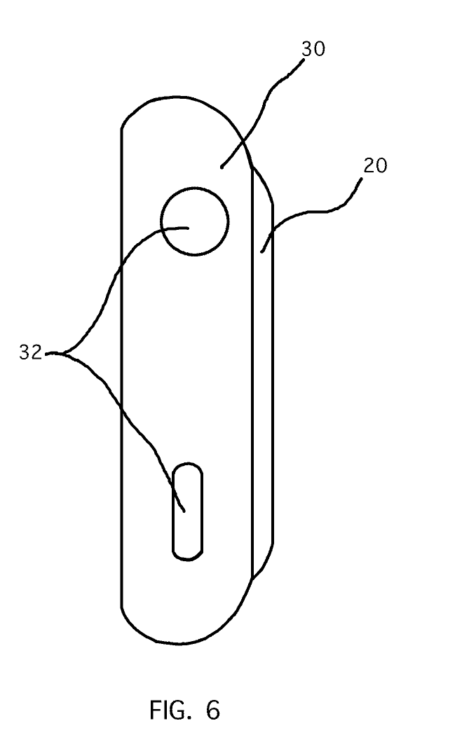

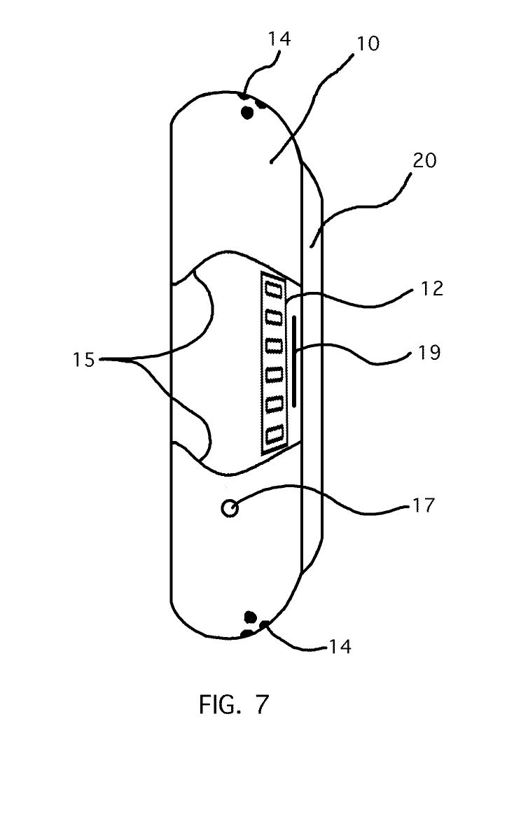

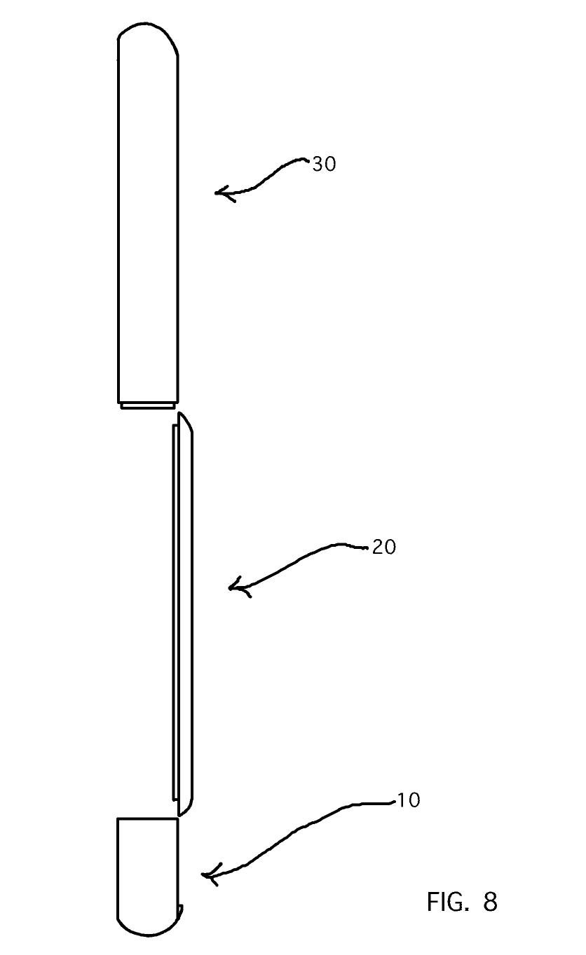

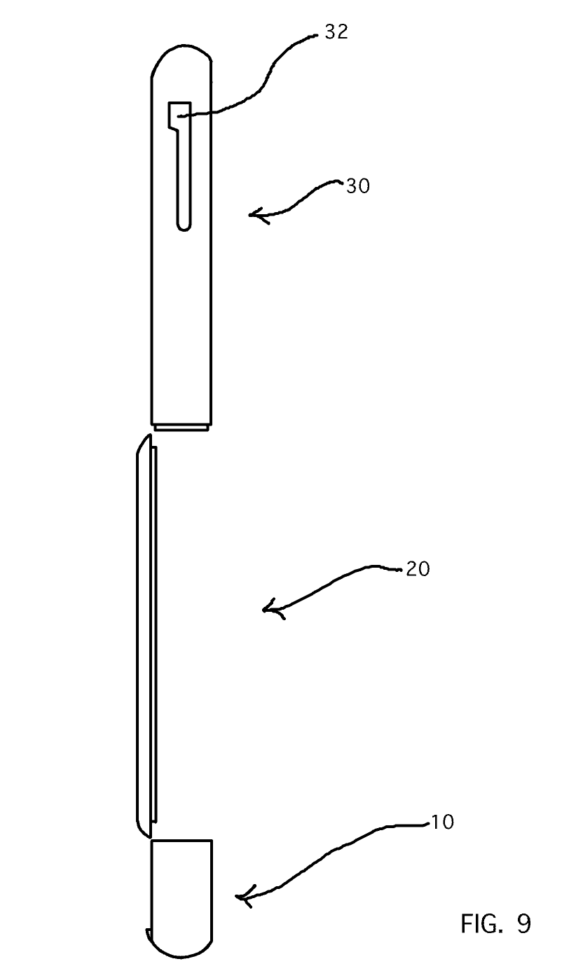

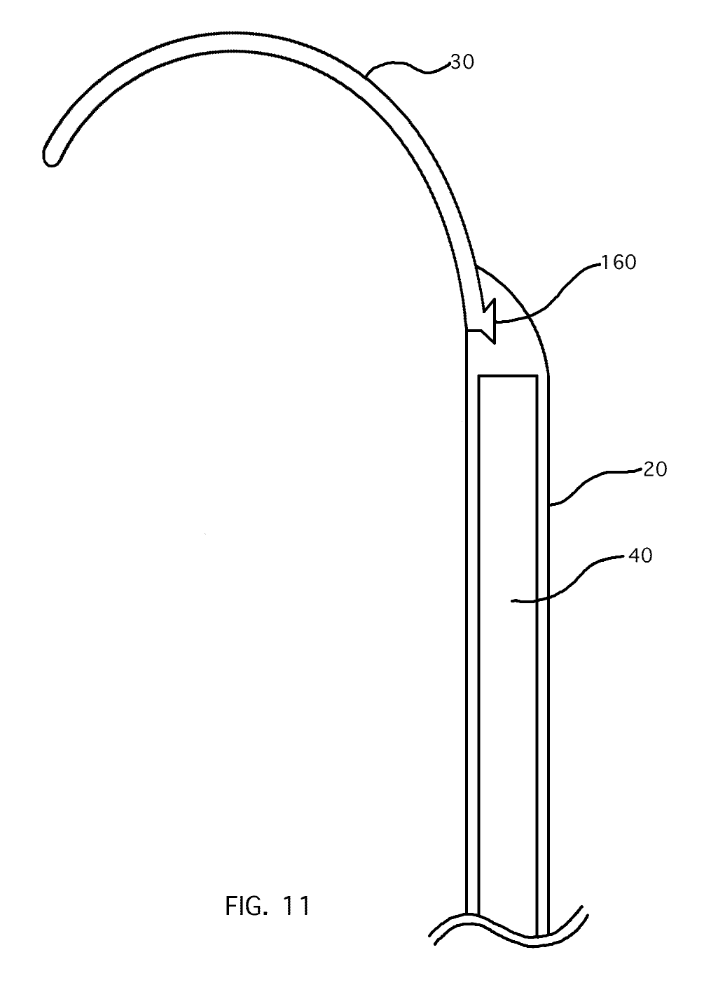

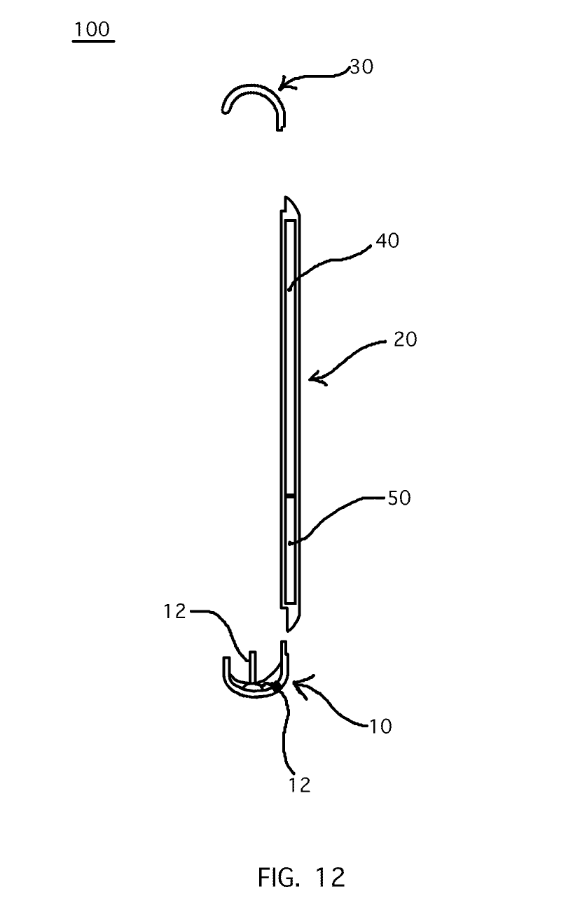

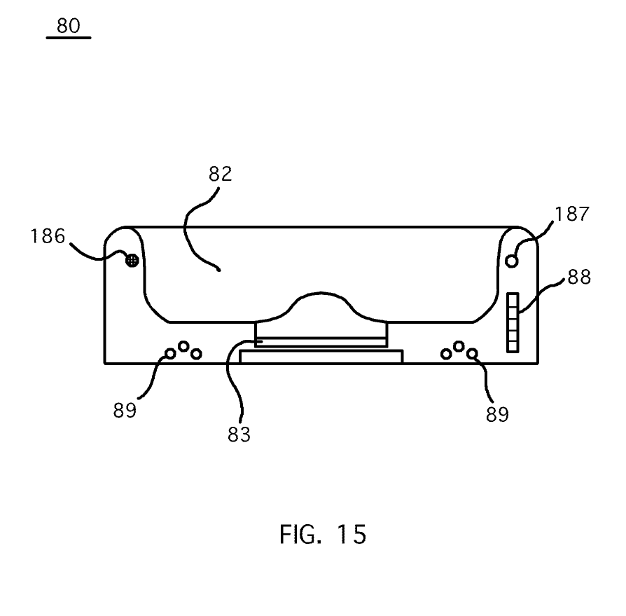

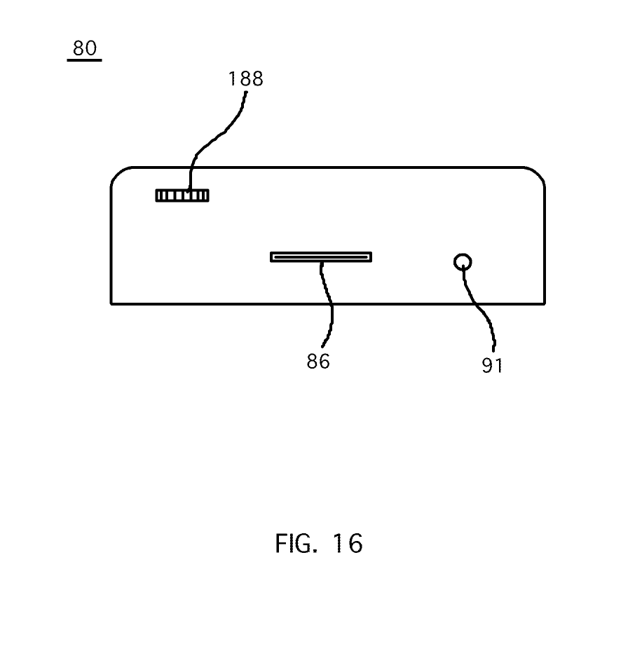

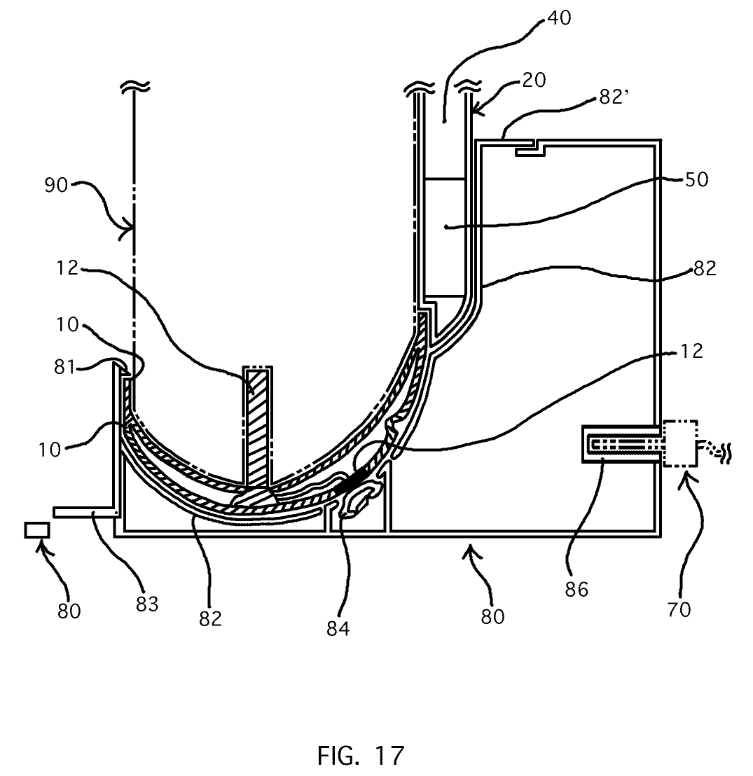

FIGS. 1-18 illustrate a case battery 100 installed on a personal electronic device 90 according to embodiments of the present invention.

An aspect of the invention provides a case battery for a personal electronic device. The case battery include a bottom holding portion 10, a rear plate portion 20, a top holding portion 30, a charging portion 40, and a circuit chamber 50.

The bottom holding portion 10 is configured to hold a lower part of the personal electronic device 90 and provide a plurality of external interfacing devices with access to the personal electronic device 90.

The rear plate portion 20 is configured to be attached detachably to the bottom holding portion 10 mechanically and electrically and protect a rear portion of the personal electronic device 90.

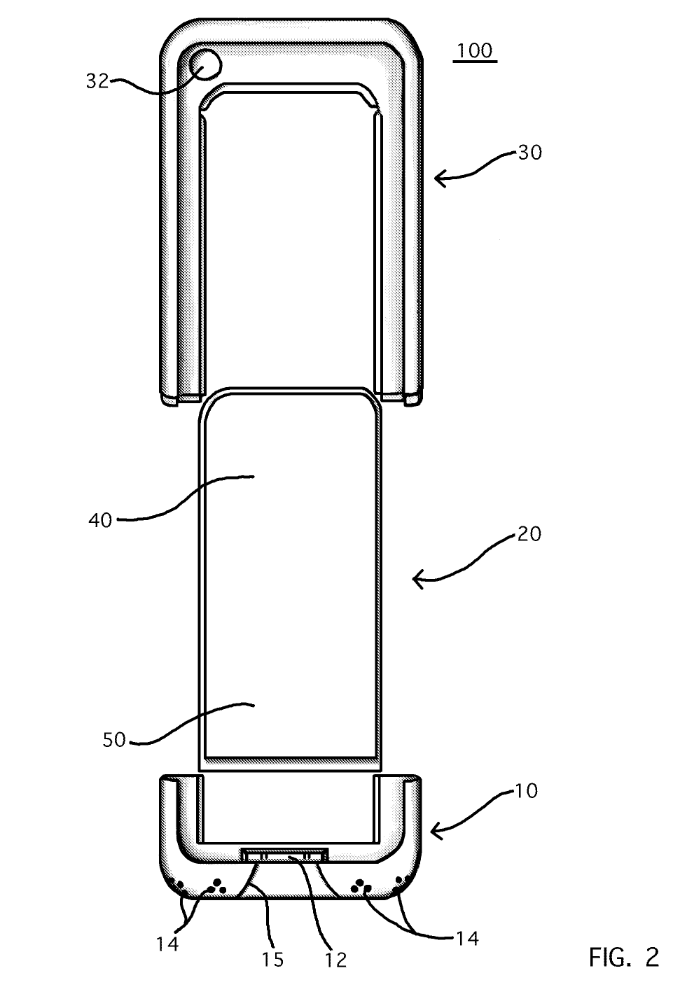

The top holding portion 30 is configured to hold a top part of the personal electronic device 90 and provide access holes to at least part of input and output devices of the personal electronic device 90. The top holding portion 30 may comprise a plurality of holes 32 to access the personal electronic device 90 as shown in FIGS. 2, 3, and 9.

The charging portion 40 is disposed in the rear plate portion 20, and configured to be electrically connected to the personal electronic device 90 while the personal electronic device 90 is installed in the case battery 100.

The circuit compartment 50 is disposed in the rear plate portion 20, and configured to connect the charging portion 40 to the personal electronic device 90.

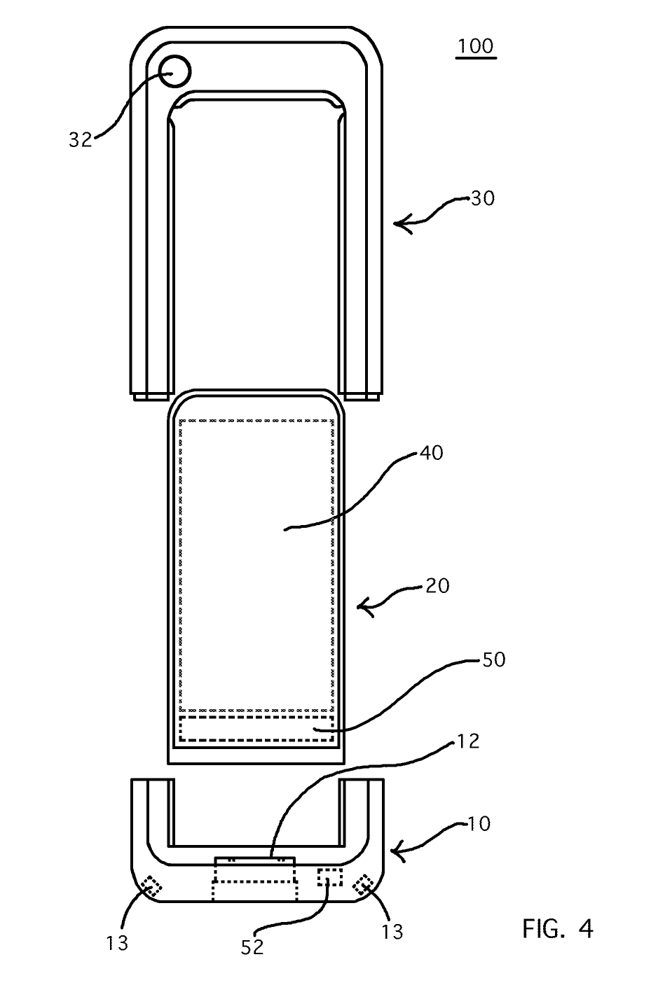

In certain embodiments of the invention, a part or entire circuit 52 in the circuit compartment 50 can be disposed in the bottom holding portion 10 as shown in FIG. 4. The rear plate portion 20 may be thinner or smaller by moving the circuitry to the bottom holding portion 10.

The bottom holding portion 10 may include a first connector 12, a plurality of holes 14, and a plurality of resonance chambers 16.

The first connector 12 may be configured to electrically connect the case battery 100 to the personal electronic device 90, and include a power connector and a electrical signal connector.

The plurality of holes 12 may be configured to pass sound from a speaker of the personal electrical device 90, and disposed on a front side or a corner between the front and rear sides of the bottom holding portion 10.

The plurality of resonance chambers 16 may be provided between the speaker of the personal electronic device 90 and the plurality of holes 12, and configured to make the sound from the case speaker 13 or the personal electronic device 90 resonate. That is, the resonance chambers 16 are located to make the sound from the personal electronic device 90 enter therein and resonate, and also the case speaker 13 is disposed so as to issue the sound into the resonance chambers 16 to be resonated. The sound can be amplified acoustically by the resonance chambers 16.

The bottom holding portion 10 may engage side edges of the personal electronic device 90 and expose a substantial part of a display screen of the personal electronic device 90.

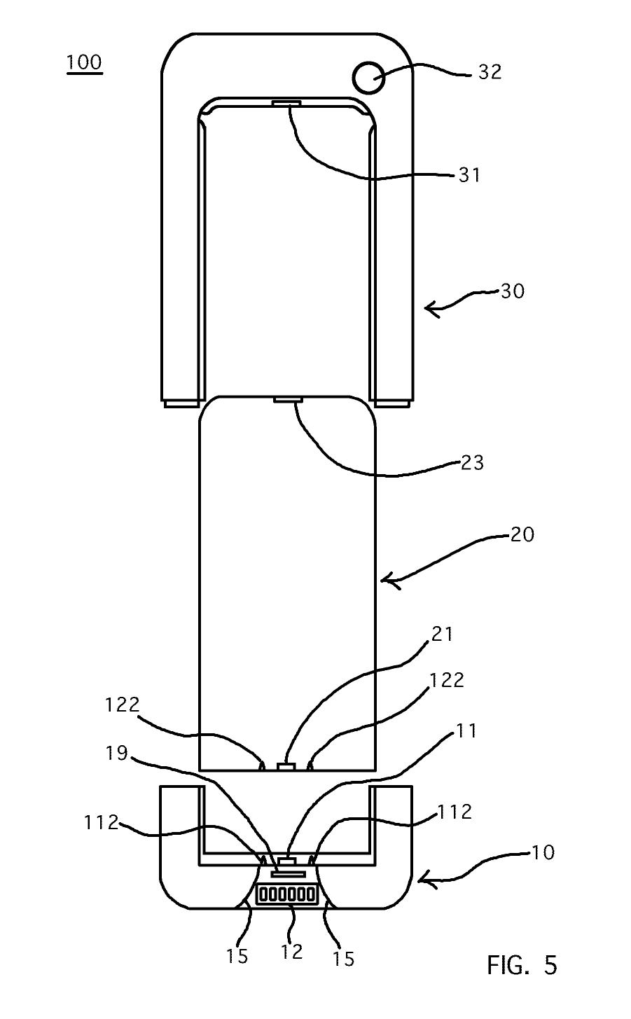

The bottom holding portion 10 may further comprise a first mechanical fastener 11, and the rear plate portion 20 may comprise a second mechanical fastener 21 corresponding to the first mechanical fastener 11. The bottom holding portion 10 and the rear plate portion 20 may be attached and locked to each other by the first and second mechanical fasteners 11, 21. The bottom holding portion 10 and the rear plate portion 20 may be electrically connected to each other through a plurality of electrical connectors 112, 122 as shown in FIG. 5.

The charging portion 40 may further include a secondary battery and configured to be charged using an external electrical power source, or a primary battery and a receptacle configured to accept the primary battery.

The circuit compartment 50 may be configured to control behaviors of the charging portion 40. The behaviors may comprise activating, deactivating, charging, and discharging.

In another embodiments of the invention, the case battery 100 may further include a connector adaptor 60, a multi-purpose connector 70, and a dock 80.

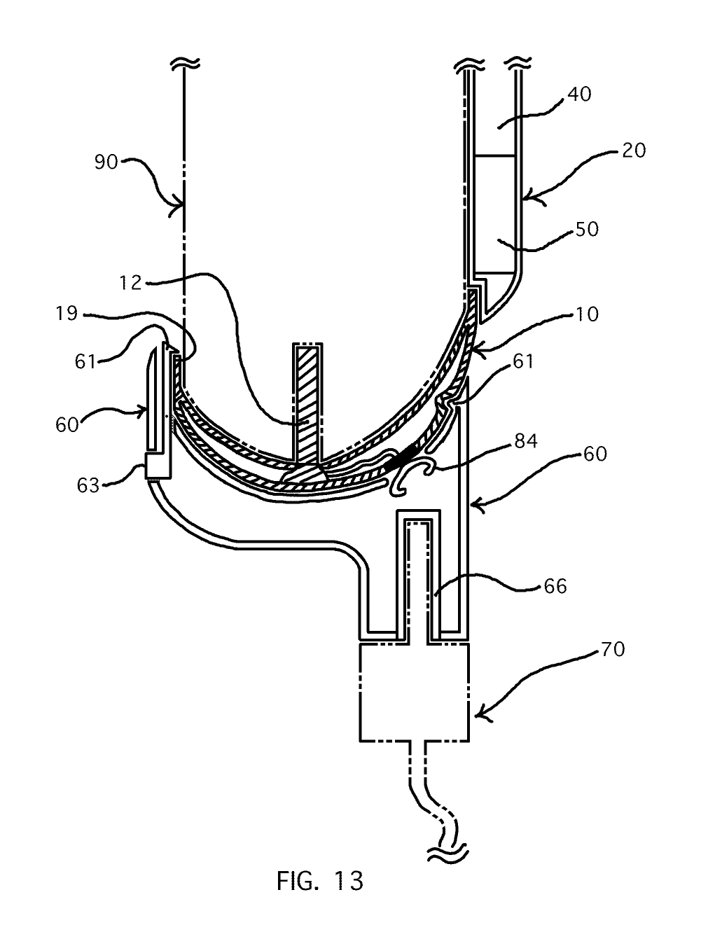

As shown in FIG. 13, the connector adaptor 60 may be configured to be attached detachably to the bottom holding portion 10, and include a plurality of locks 61 configured to lock the connector adapter 60 to the bottom holding portion 10, a release button 63 configured to release the connector adaptor 60 from the bottom holding portion 10, and a multi-purpose receptacle 66.

The multi-purpose connector 70 may be configured to be connected to the multi-purpose receptacle 66 of the connector adaptor 60, and include a USB connector and a power connector.

The dock 80 may be configured to accept the bottom holding portion 10 attached to the personal electronic device 90 and provide access to electrical power from externally to charge the charging portion 40 and access to information to communicate between the personal electronic device 90 and an external device (not shown).

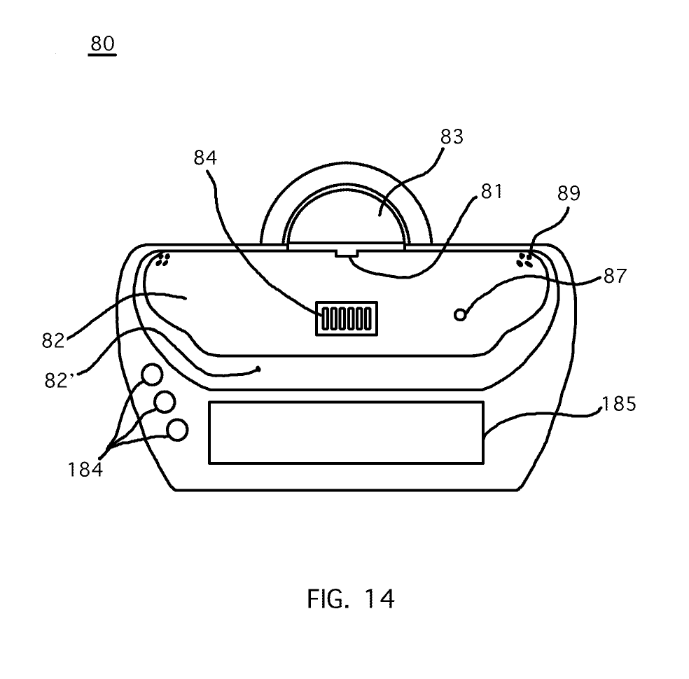

In certain embodiments as shown in FIGS. 14-17, the dock 80 may include a holding cup 82, a spring connector 84, a plurality of locks 81, a release button 83, a connector receptacle 86, and a charging indicator 88.

The holding cup 82 may be configured to accept and engage at least part of the bottom holding portion 10.

The spring connector 84 may be configured to connect the bottom holding portion 10 to the dock 80, and disposed at a bottom of the holding cup 82.

The plurality of locks 81 may be configured to lock the bottom holding portion 10 in place.

The release button 83 may be configured to release the bottom holding portion 10 from the plurality of locks 81.

The connector receptacle 86 may be configured to electrically connect the first connector 12 (refer to FIG. 2) to an external device. Alternatively, the external device can be connected to the connector receptacle 86 directly through an electric wire.

The connector receptacle 86 may be configured to accept the external device.

The charging indicator 88 may be configured to monitor a charging status of the charging portion 40 and the battery of the personal electronic device 90.

The charging portion 40 may be replaceable, and have a predetermined thickness according to a capacity of the charging portion 40. Then the holding cup 82 may be adjustable according to the various thickness and size of the case battery 100 as indicated 82′ in FIG. 14.

The bottom holding portion 10 may further include a case speaker 13 connected to the personal electronic device 90 and a deactivation switch 17 as shown in FIGS. 4, 7, and 14. The dock 80 may further include a bump 87 configured to press the deactivation switch 17 when the bottom holding portion 10 is installed on the dock 80 so as to deactivate the case speaker 13. In certain embodiments, the bump 87 can be retracted even when the bottom holding portion 10 is installed on the dock 80.

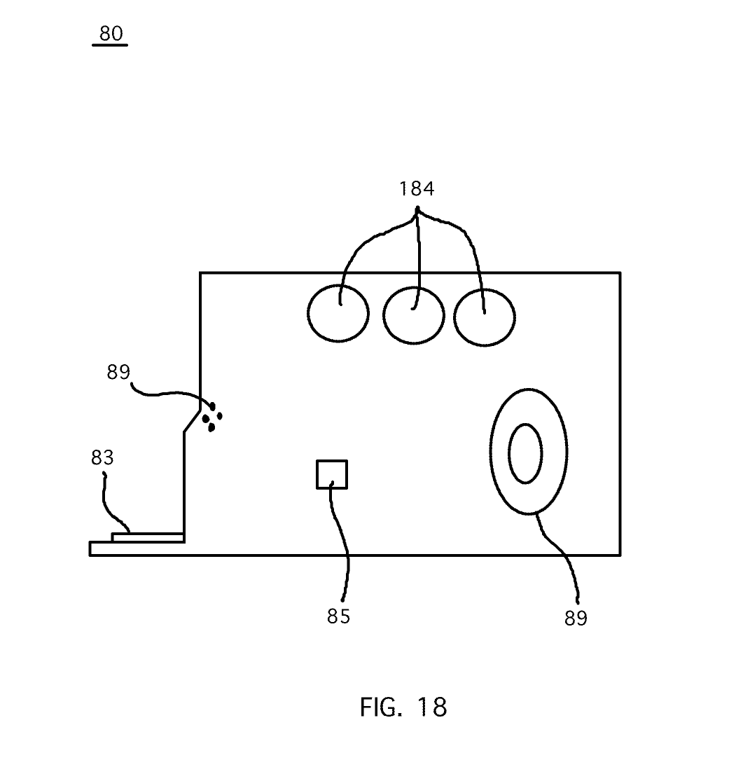

In certain embodiments of the invention as shown in FIG. 18, this can be performed by pressing a deactivation off switch 85 provided in the dock 80. In the illustrated embodiment, the dock may further comprise a speaker 89 and a plurality of controllers 184 configured to control the behaviors of the dock 80. In such embodiments, the dock 80 may further comprise a display panel 185 configured to display information from the case battery 100 or the dock 80, a microphone 186, an optical sensor 187 for a remote (not shown), and a volume control 188. The dock 80 may still further comprise AM/FM radio, antenna, and various sound controlling devices such as equalizer, frequency control, and bass booster (not shown), the behaviors of which can be controlled by the plurality of controllers 184.

The top holding portion 30 may include a third mechanical fastener 31, and the rear plate portion 20 may include a fourth mechanical fastener 23 corresponding to the third mechanical fastener 31. The top holding portion 30 and the rear plate portion 20 may be attached and locked to each other by the third and fourth mechanical fasteners 31, 23.

The connector adaptor 60 may comprise a plurality of locks 61 configured to lock the connector adapter 60 to the bottom holding portion 10, a release button 63 configured to release the connector adaptor 60 from the bottom holding portion 10, and a multi-purpose receptacle 66. The bottom holding portion 10 may further comprise a guide recess 15 and a locking recess 19 at a lower part such that the connector adapter 60 is guided to be connected to the bottom holding portion 10 as shown in FIGS. 2 and 5.

The connector adaptor 60 may include a charging status indicator 62 of the charging portion 40 and the battery of the electronic device 90.

In certain embodiments, at least part of the top, bottom, or top and bottom holding portions may be transparent so as to the personal electronic device is seen through the part of the case battery.

In certain embodiments of the invention, the connector adaptor 60 can be connected to an external device directly through an electrical wire or cable without the multi-purpose connector 70.

As shown schematically in FIG. 13, the connector adaptor 60 is configured to be connected to the bottom holding portion 10 by holding the lower part of the bottom holding portion 10 from below as if biting into it using the plurality of locks 61 as teeth in a sense. The connector adaptor 60 can be seen distinctly from the bottom holding portion 10 that is hatched in FIG. 13.

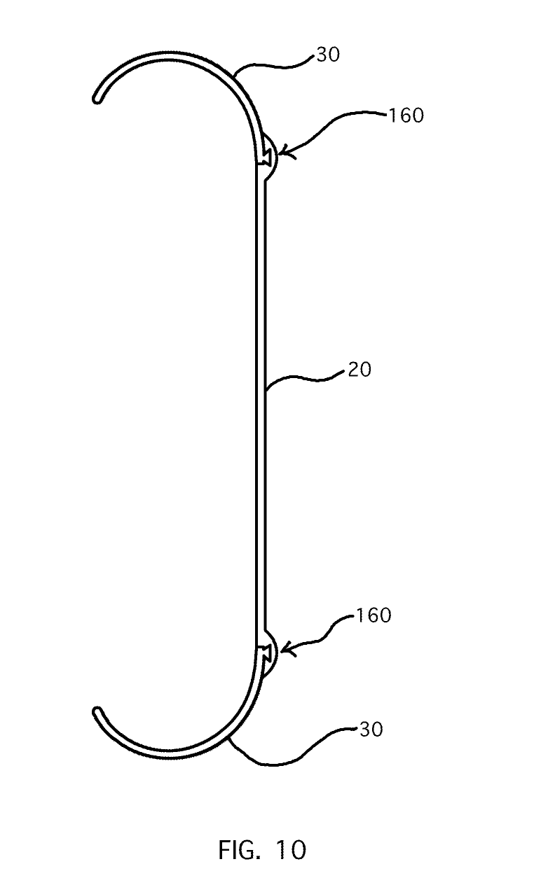

In certain embodiments, the rear plate 20 and sides of the top or bottom holding portion 30, 10 can be connected by one or more longitudinal recess rail 160 as shown in FIG. 10.

The personal electronic device may comprise a portable game machine, a cellular phone, a PDA, a palmtop, and a GPS.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A case battery for a personal electronic device, the case battery comprising:
a bottom holding portion configured to hold a lower part of the personal electronic device and provide a plurality of external interfacing devices with access to the personal electronic device;
a rear plate portion configured to be attached detachably to the bottom holding portion mechanically and electrically and protect a rear portion of the personal electronic device;
a top holding portion configured to hold a top part of the personal electronic device and provide access holes to at least part of input and output devices of the personal electronic device;
a charging portion disposed in the rear plate portion, the charging portion being configured to be electrically connected to the personal electronic device while the personal electronic device is installed in the case battery; and
a circuit compartment disposed in the rear plate portion, wherein the circuit compartment is configured to connect the charging portion to the personal electronic device.

2. The case battery of claim 1, wherein the bottom holding portion comprises:
a first connector configured to electrically connect the case battery to the personal electronic device, wherein the first connector comprises a power connector and a electrical signal connector;
a plurality of holes configured to pass sound from a speaker of the personal electrical device, wherein the holes are disposed on a front side or a corner between the front and rear sides of the bottom holding portion; and
a plurality of resonance chambers provided between the speaker and the plurality of holes, wherein the resonance chambers are configured for the sound from the speaker to resonate so as to be amplified acoustically.

3. The case battery of claim 2, wherein the bottom holding portion engages with side edges of the personal electronic device and exposes a substantial part of a display screen of the personal electronic device.

4. The case battery of claim 2, wherein the bottom holding portion further comprises a first mechanical fastener, wherein the rear plate portion comprises a second mechanical fastener corresponding to the first mechanical fastener, and wherein the bottom holding portion and the rear plate portion are attached and locked to each other by the first and second mechanical fastener.

5. The case battery of claim 1, wherein the charging portion further comprises:
a secondary battery configured to be charged using an external electrical power source; and
a primary battery and a receptacle configured to accept the primary battery.

6. The case battery of claim 1, wherein the circuit compartment is configured to control behaviors of the charging portion.

7. The case battery of claim 1, further comprising:
a connector adaptor configured to be attached detachably to the bottom holding portion, wherein the connector adaptor comprises a plurality of locks configured to lock the connector adapter to the bottom holding portion, a release button configured to release the connector adaptor from the bottom holding portion, and a multi-purpose receptacle;
a multi-purpose connector, configured to be connected to the multi-purpose receptacle of the connector adaptor, comprising a USB connector and a power connector; and
a dock configured to accept the bottom holding portion attached to the personal electronic device and provide access to electrical power from externally to charge the charging portion and access to information to communicate between the personal electronic device and an external device.

8. The case battery of claim 7, wherein the dock comprises:
a holding cup configured to accept and engage at least part of the bottom holding portion;
a spring connector configured to connect the bottom holding portion to the dock, the spring connector being disposed at a bottom of the holding cup;
a plurality of locks configured to lock the bottom holding portion in place;
a release button configured to release the bottom holding portion from the plurality of locks;
a second connector configured to electrically connect the first connector to an external device;
a connector receptacle configured to accept the external device; and
a charging indicator configured to monitor a charging status of the charging portion and the battery of the personal electronic device.

9. The case battery of claim 8, wherein the charging portion is replaceable, wherein the charging portion has a predetermined thickness according to a capacity of the charging portion, and wherein the holding cup is adjustable according to the thickness of the charging portion.

10. The case battery of claim 8, wherein the bottom holding portion further comprises a case speaker connected to the personal electronic device and an deactivation switch, wherein the dock further comprises a bump configured to press the deactivation switch when the bottom holding portion is installed on the dock so as to deactivate the case speaker.

11. The case battery of claim 1, wherein the top holding portion comprises a third mechanical fastener, wherein the rear plate portion comprises a fourth mechanical fastener corresponding to the third mechanical fastener, and wherein the top holding portion and the rear plate portion are attached and locked to each other by the third and fourth mechanical fasteners.

12. The case battery of claim 1, further comprising a connector adaptor configured to be attached detachably to the bottom holding portion, wherein the connector adaptor comprises a plurality of locks configured to lock the connector adapter to the bottom holding portion, a release button configured to release the connector adaptor from the bottom holding portion, and a multi-purpose receptacle, and wherein the bottom holding portion further comprises a guide recess at a lower part such that the connector adapter is guided to be connected to the bottom holding portion.

13. The case battery of claim 12, wherein the connector adaptor comprises a charging status of the charging portion and the battery of the electronic device.
